(19) United States
(12) Patent Application Publication
(10) Pub. No.: US 2014/0380423 A1
(43) Pub. Date: Dec. 25, 2014

(54) SYSTEM AND METHOD FOR DYNAMICALLY AWARDING PERMISSIONS

(71) Applicant: Avaya Inc., Basking Ridge, NJ (US)

(72) Inventors: Wayne Wong, Milpitas, CA (US); Rahul Buddhisagar, San Jose, CA (US); Michael Krack, St. Pete Beach, FL (US); Jeffrey Wong, San Jose, CA (US); Jai Pugalia, San Jose, CA (US); Lee Shero, McKinney, TX (US)

(21) Appl. No.: 13/924,788

(22) Filed: Jun. 24, 2013

(51) Int. Cl. H04L 29/06

(52) U.S. Cl. CPC H04L 63/08
USPC 726/4

(57) ABSTRACT

An authorization system for dynamically awarding permissions to a requestor for performing an action, based on real-time monitored statistics of the requestor. The authorization system comprises a processor and a memory. The memory further comprises a status database for storing real-time information corresponding to the requestor, and a rules database for storing rules to enable the authorization system in determining permissions for various requestors' requests to perform the action. Additionally, the memory includes a status determining module for determining status-data related to the requestor, and a permission awarding module to evaluate the status-data with a dynamically selected set of rules for awarding permission to a requestor's request. The memory further includes a risk estimation module for calculating risk associated in awarding the permission, and an action triggering module for triggering an associated action based on the calculated risk.

### BACKGROUND

1. Field of the Invention

Embodiments of the present invention provide a system and a method for authorizing a requestor to perform a requested action. More specifically, the present invention dynamically determines permissions for the requestor to perform the requested action based on real-time data corresponding to the requestor.

2. Description of Related Art

It is common practice for enterprises to restrict their employees/agents in accessing enterprise resources based on agent's ranks and their work domains. This ensures that only the authorized agents can access their designated resources, which further ensures that the resources do not get mishandled or compromised. Further, enterprises may use security systems such as web login, bio-metric login, face recognition, and the like to ensure that only authorized agents can access their designated resources. However, these systems have a limited capability of restricting unauthorized access only. These systems are unable to prevent any harm (intentional or accidental) that can be caused by the authorized agents.

Further, the conventional security systems are dependent on a static set of rules to determine whether or not a requestor should be provided a permission to perform a task as requested by the requestor. These set of rules are either time based or requestor identity based. Moreover, most of the conventional applications, operating systems, or requestor accounts are tied to a statically defined set of permission rules. For example, a typical standard requestor account may allow its requestor to view, create, and modify personal files, open shared files in read-only mode, and perform a specific set of tasks. However, these privileges are permanent in nature and once granted, stay in effect until a system administrator modifies them.

Specifically, in cases where situational revocation of a normally granted privilege or situational granting of a restricted privilege is desired, state of art technologies are dependent on human administrators. This requires a lot of time and effort of the administrator. Also, there have been significant efforts in past focused on concept of temporary permissions. For example, data access systems are available that allow controlled access to a database. However, such systems are limited to databases only and are dependent on static rules. Moreover, there are systems that lock an account after excessive login failures and can be unlocked only by manual intervention or by the passage of a predetermined time period. However, such systems are limited to authentication purpose only and are based on static rules and static evaluation of rules. Further, on-demand movie systems are available that allows a customer to access a purchased movie for a limited duration. Though the on-demand movie system is related to access permissions, the permissions are time based instead of being conditions based. There are many other similar software applications which evaluate multiple conditions before granting or denying access. However, such conditions are coded conditions and to change coded conditions, the code is required to be upgraded. This again requires a lot of time and effort of the administrator. Hence, nearly all state of the art applications and platforms utilize a rigid, predetermined requestor permission structure. A few slightly more enhanced platforms employ time-based or static rules-based permission structures. However, these systems also have limited applications due to their static nature.

Therefore, there is a need for a scalable system and method that is capable of addressing above issues for determining whether or not to permit the requestor to perform a requested task.

### SUMMARY

Embodiments in accordance with the present invention provide an authorization system for dynamically awarding permissions to requestors to perform an action based on real-time statistics of the requestors. The authorization system comprises a status determining module for receiving, via a communication interface, a request from a requestor to perform an action and determining requestor status-data related to the requestor based on the request. The authorization system further comprises a permission awarding module for evaluating the status-data with dynamically selected set of rules for dynamically awarding permission to the requestor to perform requested action based on the evaluation.

Embodiments in accordance with the present invention further provide a computer-implemented method for dynamically awarding permissions to requestors to perform an action based on real-time statistics of the requestors. The computer-implemented method includes receiving a request from the requestor to perform the action, determining status-data corresponding to the requestor based on the request, evaluating the status-data based on dynamically selected set of rules, and authorizing the requestor to perform the action based on the evaluation.

Embodiments in accordance with the present invention further provide a computer readable medium storing computer readable instructions when executed by a processor performs a method. The method includes receiving a request from a requestor to perform an action, determining status-data corresponding to the requestor based on the request, evaluating the status-data based on dynamically selected set of rules, and authorizing the requestor to perform the action based on the evaluation.

Further, the present invention can provide a number of advantages depending on its particular configuration. Embodiments of the present invention provide a mechanism which monitors conditions in real-time to dynamically determine whether a requestor should be allowed access to a shared resource or to perform a specific task. More specifically, the mechanism is automated and is capable of determining permissions on its own based on the information that is received from specific applications or databases.

Furthermore, the present invention goes beyond the state of the art technologies that utilize a rigid, predetermined time-based requestor permission structure. Embodiments of the present invention provide a mechanism that is invoked whenever a requestor attempts to access a shared resource or perform a specific task. The mechanism is configured for real-time monitoring of conditions to dynamically determine whether permission to a requestor's request should be granted or denied. Furthermore, the mechanism can invoke additional actions in addition to granting or denying for requested permissions, based upon dynamically selected pre-defined rules.

Moreover, the system and method disclosed by the embodiments of the present invention requires no manual administration of requestor permissions. This saves both time and money. Embodiments of the present invention further provide a useful and flexible approach for requestor permissions determination, which cannot be achieved by traditional requestor account management mechanisms.

These and other advantages will be apparent from the disclosure of the present invention contained herein.

The preceding is a simplified summary of the present invention to provide an understanding of some aspects of the present invention. This summary is neither an extensive nor exhaustive overview of the present invention and its various embodiments. It is intended neither to identify key or critical elements of the present invention nor to delineate the scope of the present invention but to present selected concepts of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of the present invention will become apparent upon consideration of the following detailed description of embodiments thereof, especially when taken in conjunction with the accompanying drawings, and wherein:

FIG. 1 illustrates an exemplary environment where various embodiments of the present invention are implemented;

FIG. 2 illustrates a block diagram of module set of the authorization system, in an exemplary embodiment of the present invention; and

FIGS. 3A and 3B illustrate a method for dynamically authorizing a request of a requestor based on real-time monitoring of requestor's status, in accordance with an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

### DETAILED DESCRIPTION

The present invention will be illustrated below in conjunction with an exemplary communication system. However, the present invention is not limited to any particular type of communication system. Those skilled in the art will recognize the disclosed techniques may be used in any communication application in which it is desirable to provide improved communication.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read.

A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the present invention is considered to include a tangible storage medium or distribution medium and prior art-recognized equivalents and successor media, in which the software implementations of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the present invention is described in terms of exemplary embodiments, it should be appreciated those individual aspects of the present invention can be separately claimed.

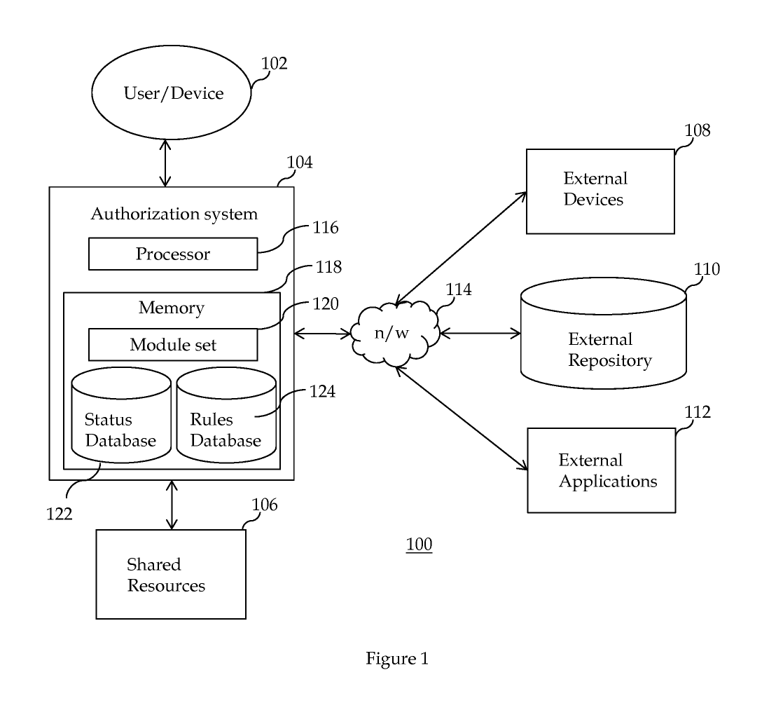

FIG. 1 illustrates an exemplary environment 100 where various embodiments of the present invention are implemented. The environment 100 includes a device/group of devices 102 (hereinafter, referred to as “device 102”) in communication with an authorization system 104. In an embodiment, the device 102 refers to a human user using a device. In another embodiment, the device 102 refers to a device that can perform without intervention of human user. Further, the device 102 may refer to an electronic device that may be utilized by its requestor to communicate with the authorization system 104. In an embodiment, the device itself may be a requestor i.e., the device may be capable of generating a request independent of any human user's intervention (based on a program's requirement or on a triggering event). Examples of the device 102 may include, but are not restricted to, a personal computer, a mobile phone, a smart phone, a personal digital assistant (PDA), a tablet computer, a laptop and the like.

In an embodiment, the device 102 may be in direct communication with the authorization system 104. In another embodiment, the device 102 may be in communication with the authorization system 104 via a network (not shown). Further, as shown, the authorization system 104 is in communication with shared resources 106, which may either be in direct communication with the authorization system 104 or may be in communication via a network (not shown). The shared resources 106 may include data, information, source codes, application, devices, or controls that may be needed by the device 102 to perform a task or action.

Further, the authorization system 104 is in communication with external devices 108, external repository 110, and external applications 112 via a network 114. In an embodiment, the external repository 110 may be a combination of one or more external repositories such as social networks, online calendars, and the like. The network 114 may include, but is not restricted to, a communication network such as the Internet, PSTN, Local Area Network (LAN), Wide Area Network (WAN), Metropolitan Area Network (MAN), and so forth. Further, external devices 108 may include devices that can be operated/monitored over the network 114. For example, a thermometer, air conditioner, computing device, and others. Further, the external repository 110 may include third party databases such as, but not limited to, a calendar, social network databases, etc. Furthermore, the external applications 112 may include, but are not limited to, behavior management applications such as “ClassDojo” or tracking applications such as “FollowMee”.

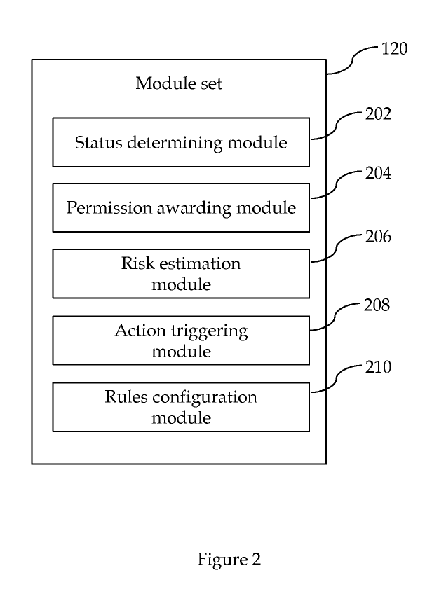

The authorization system 104 further includes a processor 116 and a memory 118. The memory 118 further includes a module set 120 comprising various modules as shown in FIG. 2. The memory further includes a status database 122 and a rules database 124. In an embodiment, the status database 122 may include information (e.g., status-data of the requestor or other statistics of the requestor) corresponding to various requestors those are registered with the authorization system 104. In an embodiment, the requestors may be human users using a device to submit a request. In another embodiment, the requestors may be devices/software programs that can submit a request with or without any intervention of human users. The information may include, but is not limited to, personal information, professional information, progress reports, medical information, demographic information, and the like. Such information may be retrieved in real-time. In an embodiment, such information (e.g., status-data) may be monitored from the external repository 110, and external applications 112. Further, in an embodiment, the status database 122 comprises real-time performance data of the requestor. In additional embodiment, the status database 122 may store performance history of the requestor.

The rules database 124 may include a set of pre-defined rules that can be configured by a human administrator of the authorization system 104. In an embodiment, the rules database 124 may include rules corresponding to a variety of tasks or actions that can be performed by the registered requestors of the authorization system 104. In another embodiment, the rules database 124 may include rules that may be used to allow or prohibit a registered requestor to access resources, such as, but not limited to, shared resources 106, external devices 108, external repository 110, and external applications 112. Further, the rules may include dynamic rules that require real-time data related to the requestor for its evaluation.

In an exemplary embodiment of the present invention, the real-time data may include performance of the requestor. For example, if an employee submits a request for bonus, then the authorization system 104 may analyze performance history of the employee to determine whether or not the employee is eligible for bonus. In another embodiment, the real-time data may include physical or logical location of the requestor. For example, if an employee requests for a cab service from an enterprise, then based on the current location of the employee the authorization system 104 of the enterprise may deny or allocate a cab to the employee. In yet another embodiment, the real-time data may include project-progress (or progress report) of the requestor. For example, in case of an employee working on a project “X” asks for leaves, then the authorization system 104 may analyze progress report of the employee to analyze progress made by the employee in the project “X” to determine whether or not the employee can be allowed to go on vacations, considering deadline for the project “X”.

Further, in an embodiment, the real-time data may include behavior history of the requestor. For example, if in a school a student requests to issue a book from the school's library, then based on the behavior history of the student, the authorization system 104 of the school may deny or issue requested book to the student. Furthermore, in another embodiment, the real-time data may include medical condition of the requestor. For example, if in a hospital, a patient requests a particular food item, then based on the present medical condition of the patient, the authorization system 104 of the hospital may allow or deny the request of the patient.

In an exemplary embodiment of the present invention, the rules may be dynamic in nature. For example, rules applicable for a certain employee may change automatically based on his/her age and/or time spent with the enterprise. In an exemplary embodiment of the present invention, the authorization system 104 may depend on the rules present in the rules database 124 for allowing permissions to its registered requestors to perform a task/action or to access a resource protected by the authorization system 104.

Further, the module set 120 may include an instruction set (not shown) that can be processed by the processor 116 to process requests received from the device 102. The instruction set may include instructions to retrieve data from the status database 122, rules database 124, external devices 108, external repository 110, and external applications 112 for processing the requests received from the device 102. For example, suppose a registered requestor accesses the shared resources and tries to check-in some source code. The authorization system 104 may then check from the status database 122 or from the external repository 110 (e.g., an online calendar or social network) if the requestor is going on vacation within next 48 hours or not (in case if the requestor is a human user). If the requestor has not planned any vacation in next 48 hours then the authorization system 104 may allow the requestor to check-in the source code. Otherwise, the authorization system 104 may not allow the requestor to check-in the source code.

In another exemplary scenario, an employee of an organization may request a central server that is implementing the authorization system 104 of the organization to switch off air conditioners. The central server may then communicate with plurality of thermometers connected with the central server to determine temperature at various parts of the organization. Based on the temperature, the central server may either completely deny the request of the employee or may accept also. In an embodiment, based on the retrieved temperature details, the central server may switch off the air conditioners only in those areas where temperature is below than a pre-determined level and may keep on the air conditioners in the areas of the organization where the temperature is above the pre-determined level.

In yet another exemplary scenario, a registered requestor may request the authorization system 104 to allow access to a file stored in the shared resources 106. The authorization system 104 may then access the status database 122 to determine real-time information corresponding to the requestor (e.g., status-data). Thereafter, the authorization system 104 may check the rules database 124 to determine rules that are relevant for the requestor's request. Suppose there is a rule that unless a registered requestor has not submitted his/her resignation letter, the registered requestor should be allowed to access shared resources 106. Then the authorization may determine from the status database 122 whether or not the registered requestor has submitted his/her resignation letter. If the registered requestor has not submitted the resignation letter then the registered requestor may be allowed to access the requested file. Conversely, if the registered requestor has already submitted resignation letter then the authorization system 104, depending upon rules, may either restrict the registered requestor from accessing the requested file or may allow the registered requestor to access the file after receiving permission from related supervisor.

FIG. 2 illustrates a block diagram of the module set 120 of the authorization system 104, in an exemplary embodiment of the present invention. The module set comprise a number of modules, such as, but are not restricted to, status determining module 202, permission awarding module 204, risk estimation module 206, action triggering module 208, and rules configuration module 210.

The status determining module 202 may be configured to receive a request from a requestor (requestor may be a human using a device or may be a device itself requesting based on a triggering event) to perform an action such as requesting access to a shared resource. The status determining module 202 may then analyze the received request to determine purpose of the requestor's request. Thereafter, based on the requestor's request, the status determining module 202 may determine status-data related to the requestor from the status database 122, external repository 110, or external applications 112. In an embodiment, in absence of required information, the status determining module 202 can consult a supervisor or caretaker of the requestor. In another embodiment, in absence of required information, the status determining module 202 may query the requestor itself corresponding to the required information.

In an embodiment, the status-data may include information corresponding to the requestor, such as, but is not restricted to, performance report, designation/rank, authorities given to requestor, work profile, academic information, personal information, professional information, geographical location of the requestor, and the like. In another embodiment, the status-data may also include real-time information such as present location of requestor, present responsibilities, present performance, present behavior, or even date and time etc. The status-data of a requestor may therefore play a major role for the authorization system 104 to dynamically determine permissions requested by the requestor.

The permission awarding module 204 may be configured to dynamically evaluate the status-data retrieved by the status determining module 202. The permission awarding module 204 may further be configured to dynamically select set of rules (that are relevant for the request of the requestor) stored in the rules database 124 for the evaluation. The dynamic selection of rules may correspond to selection of different rules for every requestor based on status-data of the requestor. In an embodiment, the rules may also be dynamically retrieved from external sources such as, but not limited to, external repository 110.

Further, the permission awarding module 204 may receive information from the status determining module 202 corresponding to the purpose of the requestor's request. The permission awarding module 204 may then analyze the purpose of the requestor's request to search and retrieve only relevant rules (based on requestor's request and status-data of the requestor) according to the requestor's query/request. For example, rules for a requestor working in USA may be different than rules for a requestor working in Asia (considering that both requestors submitted same request, such as a request to go on vacation). Thereafter, based on the retrieved relevant rules, the permission awarding module 204 may further evaluate the status-data of the requestor to determine whether or not to permit the request of the requestor. Thus, the system applies different rules to different requestors based on difference in their status-data. For example, if a programmer requested the authorization system 104 to submit a program code into the shared resources 106, then the authorization system 104 may access the status database 122 to access saved performance history of the programmer. Based on the saved performance history, the authorization system 104 may determine a number of times when code submitted by the programmer crashed. Based on this information, the authorization system 104 may either allow the code to be submitted or may stop the code from submission. In an embodiment, the authorization system 104 may allow the code to be submitted only if the programmer gets the code verified.

The risk estimation module 206 may be configured to analyze decisions made by the permission awarding module 204 in permitting requestor's requests. In an embodiment, the risk estimation module 206 may use the status-data retrieved by the status determining module 202, rules retrieved by the permission awarding module 204, and decisions made by the permission awarding module 204 for estimating the risk taken by the permission awarding module 204 in making decisions. In an embodiment, the risk estimation module 206 may be configured to estimate risk only in cases where the permission awarding module 204 permits a requestor's request.

Further, in an embodiment, rules stored in the rules database 124 may have a score or ranking (generically, “ranking”) to determine importance and/or weight of the rules. Such ranking may help the permission awarding module 204 and risk estimation module 206 in making decisions, i.e., if a high ranked rule is not satisfied by status-data of a requestor then the permission awarding module 204 deny corresponding requestor's request. However, suppose a mid-ranked rule is not satisfied by the status-data, then the permission awarding module 204 may still grant the requestor's request. Thereafter, the risk estimation module 206 may calculate risk involved in granting the requestor's request based on ranking of rules and requestor status-data. In this case, if the calculated risk crosses a pre-determined threshold level (hereinafter, referred to as “risk-threshold”), then the risk estimation module 206 may inform the action triggering module 208 to perform a required action.

The action triggering module 208 may be configured to receive information from the risk estimation module 206 corresponding to a risk-threshold breach. The action triggering module 208 may then retrieve information such as status-data, purpose of requestor's request, and relevant rules for the requestor's request from the risk estimation module 206. In an embodiment, the rules database 124 may also include conditions for triggering a specific action on a breach of risk-threshold. The specific actions may depend on the requestor's requests, status-data, relevant rules, and ranking of relevant rules. The action triggering module 208 may then search the rules database 124 to search and retrieve relevant conditions corresponding to calculated risk. Thereafter, the triggering module 208 may execute relevant actions as defined in the relevant conditions.

For example, if the permission awarding module 204 allowed a programmer to submit a program code into the shared resources 106 even after determining that last code submitted by the programmer crashed when executed, then the risk estimation module 206 may warn the action triggering module 208 corresponding to the submission of the program code. The action triggering module 208 may then send via a communication interface a notification to requestor's supervisor, or to the other programmers those are working on same project, corresponding to the newly submitted code along with associated risk. Such action may be determined by the action triggering module 208 from the rules database 124.

Rules configuration module 210 may be configured to modify, add, or delete rules from the rules database 124. In an embodiment, the rules configuration module 210 may receive direct inputs from a human administrator. This may enable a human administrator to configure or update rules stored in the rules database. In another embodiment, the risk estimation module 206 may be configured to modify specific rules to minimize risk associated with specific requestor's requests.

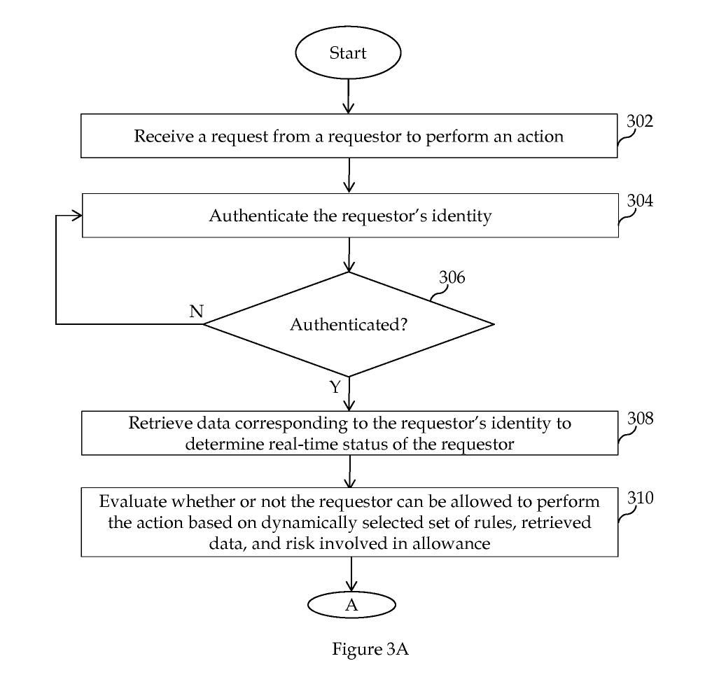

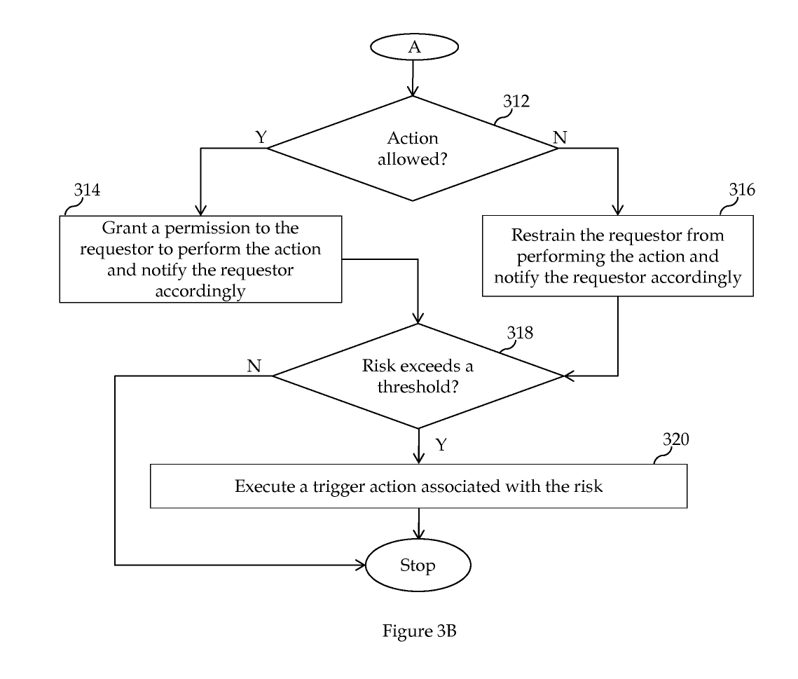

FIGS. 3A and 3B illustrate a method for dynamically authorizing a requestor's request based on real-time monitoring of requestor's status, in accordance with an embodiment of the present invention. In an embodiment, the requestor may be a human user using a device to submit a request. In another embodiment, the requestor may be a device that can submit a request without any intervention of human user (based on triggering actions). At step 302, a system such as authorization system 104 may receive a request from a requestor to perform an action, such as a request for accessing a shared resource, e.g., a student attempting to connect to the Internet.

At step 304, the authorization system 104 may ask the requestor to login to connect to the Internet. The requestor may then enter login credentials to authenticate his/her identity. At step 306, the authorization system 104 may determine whether or not the login credentials entered by the requestor are valid. If the requestor is authenticated then the method may proceed to step 308. If not authenticated, the method may start again from step 304 to authenticate the requestor.

At step 308, the authorization system 104 may use databases present internal and external to the system, such as status database 122, external repository 110, external applications 112, for retrieving real-time monitored data (hereinafter, referred to as “status-data”) corresponding to the authenticated requestor. Additionally, based on the requestor's request and the status-data the authorization system 104 may search and retrieve relevant rules from a database such as rules database 124. In an embodiment, step 308 may be performed by the status determining module 202.

At step 310, the authorization system 104 evaluates whether or not the requestor can be allowed to perform requested action based on the retrieved data, risk involved in allowance, and dynamically selected set of relevant rules. The relevant rules may be selected dynamically based on the status-data of the requestor i.e. different rules may be selected for different requesters based on the difference in their status-data. After dynamic selection of relevant rules, the authorization system 104 may determine whether or not the rules allow the requested action based on the retrieved status-data. In an embodiment, if the retrieved real time status-data of the requestor satisfies a relevant rule then the authorization system 104 may allow the requestor a permission to perform requested action. In another embodiment, if there are more than one relevant rules then the authorization system 104 may only allow permission if the status-data of the requestor satisfies all relevant rules.

Additionally, in an embodiment of the present invention, the authorization system 104 may estimate risk involved in allowing or denying the requested action. In an embodiment, the authorization system 104 may refer to ranking of the relevant rules, status-data, and the requestor's request to calculate risk associated in granting or preventing the requestor from performing requested action. In case, if the estimated risk is more than a pre-determined level then the authorization system 104 may not allow the requested action. In another case, if the estimated risk is below the pre-determined level then the authorization system 104 may allow the requested action (considering that other dynamically selected rules also allow the requested action). In an embodiment, if the estimated risk is closely below the pre-determined level then the authorization module may consult a human supervisor before allowing the requested action.

For example, if a student tried to connect to the Internet, then the authorization system may access the student's class performance monitoring system to determine the student's performance. If the authorization system 104 determined that the student's performance meets or exceeds one or more predetermined performance thresholds, then the authorization system 104 may allow the student to connect his/her computer to the Internet. In another embodiment, suppose a student requests to connect to the Internet. Based on rules, the authorization system may also check whether or not the student has completed his/her homework and/or assignment in order to determine whether to allow the student to connect to the Internet. Further, if the authorization system 104 denies the student from connecting to the Internet, then the authorization system 104 may record the request and the corresponding action for future reference or to inform parents or teachers.

Referring now to FIG. 3B, at step 312 the authorization system 104 may ensure that, according to the relevant rules, the requestor's request can be allowed based on status-data, then the authorization system 104 may allow the requestor to perform requested action at step 314. Otherwise, if relevant rules do not allow the requestor's request based on the requestor's status-data then, at step 316, the authorization may restrain the requestor from performing the action. In an embodiment, step 310 to step 316 may be performed by the permission awarding module 204.

At step 318, the authorization system 104 may determine whether the risk estimated at the step 310 in denial or acceptance of the requested action exceeds a pre-set threshold or not. If the authorization system 104 determines that the calculated risk is greater than a pre-determined threshold value then the method may proceed to step 320, otherwise the method may end. In an embodiment, step 318 may be performed by the risk estimation module 206. Further, at step 320, the authorization system 104 may search the rules database 124 to determine a suitable action to be performed based on the risk taken in allowing or not allowing the requestor in performing the requested action. The authorization system 104 may then perform the determined action associated with risk taken in allowing the requestor in performing requested action. In an embodiment, step 320 may be performed by the action triggering module 208.

For example, suppose the authorization system 104 allowed a student's request to connect to the Internet after determining that the student has completed his/her assignments, but further suppose that the student is not behaving well in class. Then the authorization system 104 may determine that there is a risk in allowing the student to connect to the Internet (e.g., access to adult content) without providing a benefit to the student's behavior in class. After determining such risk, the authorization system 104 may send via a communication interface a notification to the student's parents, teachers, or guardians to let them know that the student is allowed access to use the Internet. Thereafter, the parents or the teachers may instruct the authorization system 104 to either let the student use the Internet or to stop the student from using the Internet. The authorization system 104 may then follow the instructions received from the teachers or the parents and may use the received instruction as a future reference while deciding whether or not to allow the student to connect to the Internet.

Further, in an embodiment, if the rules in rules database 124 are modifiable, then the authorization system 104 may allow an authenticated human administrator to configure the rules. In an embodiment, the authorization system may automatically modify and/or configure the rules based on the risk estimation or status-data. In another embodiment, the authorization system 104 may set specific rules for specific requestors based on status-data of a requestor.

### Example

An example will now be discussed to illustrate the above principles. The following example illustrates working of the present invention in accordance with an embodiment of the present invention. A person of ordinary skilled in the art will appreciate that the present invention may be performed within any enterprise and is not limited to any particular enterprise or communication framework of the enterprise.

A software project is under process in which users of source code control systems are required to check files in and out from the system to build an application. A source code control system implementing an authorization system may dynamically review check-in and check-out requests of the users based on pre-defined rules (that may be selected dynamically) and real-time monitored statistics of the users (e.g., status-data). For example, based on user status-data and pre-defined rules, the source code control system may (a) disallow a user from checking in files “X” days prior to going on vacation based on status-data comprising information retrieved from user's Outlook calendar, (b) disallow the user from checking in files “X” days prior to going on vacation if he/she attempts to check-in more than “Y” lines of code based on status-data comprising information corresponding to user's request to check-in “Y” lines of code, (c) disallow the user from checking in files “X” days prior to going on vacation if he/she has caused “Y” build failures within the past “Z” days based on status-data comprising information corresponding to user's performance history. In addition to aforementioned scenarios, the authorization system 104 may perform certain triggered actions such as sending a conditional or automatic notification to source code control administrator/supervisor if risk associated with code check-in exceeds a pre-defined threshold.

The exemplary systems and methods of this present invention have been described in relation to a communication system. However, to avoid unnecessarily obscuring the present invention, the preceding description omits a number of known structures and devices. This omission is not to be construed as a limitation of the scope of the claimed invention. Specific details are set forth to provide an understanding of the present invention. It should however be appreciated the present invention may be practiced in a variety of ways beyond the specific detail set forth herein.

Furthermore, while the exemplary embodiments of the present invention illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a switch, server, and/or adjunct, or collocated on a particular node of a distributed network, such as an analog and/or digital telecommunications network, a packet-switch network, or a circuit-switched network.

It will be appreciated from the preceding description, and for reasons of computational efficiency, that the components of the system can be arranged at any location within a distributed network of components without affecting the operation of the system. Further, one or more functional portions of the system could be distributed between a telecommunications device and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the present invention.

A number of variations and modifications of the present invention can be used. It would be possible to provide for some features of the present invention without providing others.

For example in one alternative embodiment, the systems and methods of this present invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like.

In general, any device(s) or means capable of implementing the methodology illustrated herein can be used to implement the various aspects of this present invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment of the present invention, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this present invention is dependent on the speed and/or efficiency requirements of the system, the particular function, and the particular software or hardware systems or microprocessor or microcomputer systems being utilized.

In yet another embodiment of the present invention, the disclosed methods may be partially implemented in software that can be stored on a storage medium, executed on programmed general-purpose computer with the cooperation of a controller and memory, a special purpose computer, a microprocessor, or the like. In these instances, the systems and methods of this present invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the present invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the present invention has been presented for purposes of illustration and description. The foregoing is not intended to limit the present invention to the form or forms disclosed herein. In the foregoing Detailed Description for example, various features of the present invention are grouped together in one or more embodiments, configurations, or aspects for the purpose of streamlining the disclosure. The features of the embodiments, configurations, or aspects of the present invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. An authorization system comprising:
a processor coupled to a memory, the memory configured to store instructions that, when executed by the processor, provide:
a status determining module for determining status-data related to a requestor based on a request from the requestor to perform an action, wherein the status-data comprises real-time data related to the requestor; and
a permission awarding module for evaluating the status-data based on dynamically selected set of rules to award permission to the requestor for performing the action based on the evaluation.

2. The authorization system of claim 1, wherein the dynamically selected set of rules comprises selecting different rules for different requestors based on status-data of the requestors.

3. The authorization system of claim 1, wherein the real-time data related to the requestor comprises behavior history of the requestor.

4. The authorization system of claim 1, wherein the real-time data related to the requestor comprises medical condition of the requestor.

5. The authorization system of claim 1, wherein the real-time data related to the requestor comprises location of the requestor.

6. The authorization system of claim 1, wherein the real-time data related to the requestor comprises progress report of the requestor.

7. The authorization system of claim 1, wherein the status determining module retrieves the status-data from an external repository or device.

8. The authorization system of claim 7, wherein the external repository comprises one of a calendar, or a social networking repository.

9. The authorization system of claim 1, wherein the requestor is one of a human or a device.

10. The authorization system of claim 1, further comprising a risk calculation module for calculating a risk in awarding permission.

11. The authorization system of claim 10, further comprising an action triggering module for triggering an action based on the calculated risk.

12. The authorization system of claim 11, wherein the action triggering module comprises a communication interface configured to send a notification to a supervisor of the requestor.

13. The authorization system of claim 1, further comprising a rules configuring module for allowing an administrator to configure set of rules.

14. A computer-implemented method for authorizing a requestor to perform an action, the computer-implemented method comprising:
receiving a request from the requestor to perform the action;
determining status-data corresponding to the requestor based on the request;
evaluating the status-data based on dynamically selected set of rules; and
authorizing the requestor to perform the action based on the evaluation.

15. The computer-implemented method of claim 14, further comprising the step of determining a risk based on the evaluation.

16. The computer-implemented method of claim 15, further comprising the step of triggering an action based on the determined risk.

17. The computer-implemented method of claim 16, wherein the step of triggering an action comprises the step of sending a notification to a supervisor of the requestor.

18. The computer-implemented method of claim 14, wherein the step of determining status-data comprises the step of retrieving real-time data corresponding to the requestor from an external repository or device.

19. The computer-implemented method of claim 14, wherein the request to perform the action comprises a request to access a shared resource.

20. A non-volatile computer readable medium configured to store computer readable instructions that, when executed by a processor, perform a method comprising the steps of:
receiving, via a communication interface, a request from a requestor to perform an action;
determining status-data corresponding to the requestor based on the request;
evaluating, by the processor, the status-data based on dynamically selected set of rules; and
authorizing the requestor to perform the action based on the evaluation.
